(19) United States
(12) Patent Application Publication
(10) Pub. No.: US 2013/0072588 A1
(43) Pub. Date: Mar. 21, 2013

(54) MEDIUM DENSITY FOAMS HAVING GOOD IMPACT RESISTANCE AND A PROCESS FOR THEIR PRODUCTION

(71) Applicants: James W. Rosthauser, Pittsburgh, PA (US); James P. Kotar, McMurray, PA (US); Usama E. Younes, McMurray, PA (US)

(72) Inventors: James W. Rosthauser, Pittsburgh, PA (US); James P. Kotar, McMurray, PA (US); Usama E. Younes, McMurray, PA (US)

(73) Assignee: Bayer MaterialScience LLC, Pittsburgh, PA (US)

(21) Appl. No.: 13/238,071

(22) Filed: Sep. 21, 2011

(51) Int. Cl. C08L 75/04; B29C 44/34; C08L 75/08

(52) U.S. Cl. 521/170; 264/53

(57) ABSTRACT

Impact resistant, medium density molded polyurethane foams are produced by the process of the present invention. These foams include from 5 to 35% by weight of glass fibers having an average fiber length of from 12.5 to 50 mm and from 25 to 60% by weight of one or more particulate fillers having an average particle size of from 0.3 to 40 microns.

### BACKGROUND OF THE INVENTION

This invention relates to medium density, highly filled polyurethane molded foams having good impact resistance and a process for their production.

Polyurethane foams are used for a wide variety of applications, such as thermal insulation, building materials and structural materials. An important factor to be considered in employing polyurethane foams for such applications is their impact resistance.

It is known to use glass fibers to reinforce polyurethanes in order to improve the impact resistance of polyurethane. See, for example, U.S. Pat. Nos. 5,468,432; 5,538,786; and 6,217,805. However, the amount of filler other than rigid fibers such as glass fibers to be included in such polyurethanes has been limited to amounts such as those taught in U.S. Pat. Nos. 5,468,432 and 5,538,786, i.e., no more than 15% by weight filler, based on the weight of the polyurethane article.

It would therefore be advantageous to develop a process for producing medium density impact resistant polyurethane foams in which a large amount of relatively inexpensive filler material is used without adversely affecting the physical properties of the foam product.

### SUMMARY OF THE INVENTION

It is an object of the present invention to provide a process for the production of glass reinforced, impact resistant, molded, medium density (i.e., 10 to 50 pcf; 0.16-0.80 gm/cm³) polyurethane foams with significantly larger amounts of inexpensive filler than prior art systems.

It is another object of the present invention to provide a composition for the production of glass reinforced, impact resistant, molded, medium density polyurethane foams which are water blown and include a substantial amount of inexpensive filler material.

These and other objects which will be apparent to those skilled in the art are accomplished by including from 5 to 35% by weight, based on total weight of the foam, of glass fibers having a length of from 12.5 to 50 mm and from 25 to 60% by weight, based on total weight of the foam, of a filler which is not a glass fiber having an average particle size of from 0.3 to 40 microns in the polyurethane foam-forming reaction mixture.

### DETAILED DESCRIPTION OF THE INVENTION

The present invention relates to a process for the production of glass reinforced, impact resistant, molded, medium density polyurethane foams and to the foams produced by this process.

In the process of the present invention,

a) a polyurethane-forming reaction mixture,

b) from about 5 to about 35% by weight, based on the total weight of the foam-forming system, preferably, from about 10 to about 30% by weight of glass fibers having a length of from 12.5 to 50 mm, preferably, about 25 mm,

c) from about 25 to about 60% by weight, based on the total weight of the foam, preferably, from about 30 to about 55% by weight of a filler different from b) and which has an average particle size of from 0.3 to 40 microns and

d) a blowing agent which includes water

are reacted in a mold in amounts such that the total % by weight is 100%.

In the process of the present invention, the polyurethane foam-forming mixture employed generally includes:

a) from about 10 to about 35%, and preferably from about15 to about 30% by weight, based on total weight of the foam-forming system, of an isocyanate-reactive component and

b) from about 10 to about 35%, and preferably from 15 to 30% by weight, based on total weight of the foam-forming system, of an isocyanate component.

In the process of the present invention for preparing impact resistant, molded, medium density polyurethane foams, the polyurethane foam-forming composition together with the required amount of glass fiber, filler and blowing agent is introduced into an open mold, the mold is closed, the polyurethane-forming composition is allowed to react, and the molded polyurethane foam is removed from the mold. In a particularly preferred embodiment of the process of the present invention, the filler having an average particle size of from 0.3 to 40 microns is incorporated into the isocyanate-reactive component and the glass fibers are added as a separate stream into the vessel or mixhead in which the isocyanate and isocyanate-reactive component are combined.

As used herein, unless otherwise expressly specified, all of the numerical ranges, amounts, values and percentages such as those for amounts of materials, times and temperatures of reaction, ratios of amounts, values for molecular weight, and others in the following portion of the specification may be read as if prefaced by the word “about” even though the term “about” may not expressly appear with the value, amount or range.

Suitable polyurethane foam-forming reactive mixtures useful in the practice of the present invention include water blown polyurethane foam forming reactive mixtures in which the amount of water present is sufficient to produce a medium density foam, i.e., a foam having a density of about 10 to about 50 pcf (0.16-0.80 g/cm³). Typically, foam densities in the range of from 10 to 50 pcf (0.16-0.80 g/cm³ are achieved by using from about 0.1 to about 1.0 (and preferably about 0.2 to about 0.7) parts by weight of water, based on 100 parts by weight of the polyurethane foam-forming system. The amount of water in the foam-forming mixture is the total amount in the reactive mixture and includes water that may be adsorbed onto the hygroscopic surfaces of the flame retardant solids.

Suitable polyurethane foam-forming reactive mixtures typically include: (1) an isocyanate component, (2) one or more isocyanate-reactive components, and (3) a blowing agent that is optionally included in the isocyanate-reactive component.

In the present invention, the isocyanate component (1) may include a polymethylene poly(phenyl isocyanate) (“PMDI”), an isocyanate group-containing prepolymer based on a polymethylene poly(phenyl isocyanate), a urethane-modified polymethylene poly(phenyl isocyanate), any of the isomeric mixtures of diphenyl methane diisocyanate (“MDI”), a carbodiimide of MDI, an allophanate of MDI, and/or any mixture thereof. The isocyanate(s) included in the isocyanate component generally have an NCO group content of from 25 to 33% by weight. It is more preferred that these polyisocyanates be compositions having a functionality of from about 2.1 to about 3.8, and an NCO group content of from about 25% to about 33%, and a viscosity of less than about 1000 mPa·s at 25° C.

The polyisocyanate(s) will typically have an NCO functionality of at least 2.1, preferably at least 2.3 and most preferably at least 2.5. These polyisocyanates also typically have an NCO functionality less than or equal to 3.8, preferably less than or equal to 3.5 and most preferably less than or equal to 3.2. The polyisocyanate(s) used in the practice of the present invention may have an NCO functionality ranging between any combination of these upper and lower values, inclusive, e.g. from 2.1 to 3.8 preferably from 2.3 to 3.5 and more preferably from 2.5 to 3.2.

The polyisocyanate(s) employed in the practice of the present invention typically have an NCO group content of at least 25% by weight, preferably at least 27.5% by weight and most preferably at least 29% by weight. These polyisocyanates also typically have an NCO group content of less than or equal to 33% by weight, preferably less than or equal to 32% by weight and more preferably less than or equal to 31% by weight.

Suitable polyisocyanates may have an NCO group content ranging between any combination of these upper and lower values, inclusive, e.g., from 25% to 33% by weight, preferably from 27.5% to 32% by weight, and more preferably from 29% to 31% by weight.

It is most preferred that the polyisocyanate(s) have an NCO group content of from 27.5% to 32% and a functionality of from 2.3 to 3.5. Suitable polyisocyanates satisfying these NCO group content and functionality criteria include: polymethylene poly(phenyl isocyanates) and prepolymers thereof having the required NCO group content and functionality.

Polymeric MDI as used herein, refers to polymethylene poly(phenyl isocyanate) which in addition to monomeric diisocyanate (i.e., two-ring compounds) also contains three-ring and higher ring containing products.

A particularly preferred polyisocyanate is a polymethylene poly(phenylisocyanate) having an NCO content of about 31.5%, a functionality of about 2.8 and a viscosity of about 200 mPa·s at 25° C.

Prepolymers suitable for use in the practice of the present invention include those prepolymers prepared by reacting an excess of a polymethylene poly(phenyl isocyanate) with an isocyanate-reactive component to form an NCO terminated prepolymer. Such isocyanate-terminated prepolymers are disclosed, for example, in U.S. Pat. No. 5,962,541, the disclosure of which is hereby incorporated by reference. In the practice of the present invention, the polymeric diphenylmethane diisocyanate is reacted with a polyol, preferably a polyester polyol or a polyol blend having a functionality of from about 1.8 to about 4, and a number average molecular weight (as determined by end-group analysis) of from about 400 to about 2000. These prepolymers should have functionalities and NCO group contents within the ranges set forth above.

Suitable polyols for preparing such isocyanate-terminated prepolymers typically have a functionality of at least about 1.8, and more preferably at least about 1.9. These polyols also typically have functionalities of less than or equal to about 4, more preferably less than or equal to about 2.4, and more preferably less than or equal to about 2.2. In addition, the polyol may have a functionality ranging between any combination of these upper and lower values, inclusive, e.g. from 1.8 to 4, preferably from 1.8 to 2.4, and more preferably from 1.9 to 2.2.

The polyols used to prepare isocyanate-terminated prepolymers suitable for use in the practice of the present invention also typically have a number average molecular weight of at least about 400, and more preferably at least about 450. These polyols also typically have a number average molecular weight of less than or equal to 2000, preferably less than or equal to 800 and most preferably less than or equal to 500. These polyols may also have number average molecular weights ranging between any combination of these upper and lower values, inclusive, e.g. from 400 to 2000, preferably from 400 to 800, and more preferably from 450 to 500.

A particularly preferred polyisocyanate prepolymer comprises a reaction product of polymethylene poly(phenylisocyanate) and a 450 number average molecular weight polyester polyol which prepolymer has an NCO content of about 30.5%, a functionality of about 2.8, and a viscosity of about 350 mPa·s at 25° C.

Isocyanate-reactive components useful for the production of polyurethane foams in accordance with the present invention include: one or more higher molecular weight components (i.e., isocyanate-reactive materials having a number average molecular weight greater than 450) and one or more lower molecular weight (number average molecular weight no greater than 450) components. Examples of suitable isocyanate-reactive components that have higher molecular weights include compounds such as polyether polyols, polyester polyols, polycarbonate diols, polyhydric polythioethers, polyacetals, aliphatic thiols, solids containing polyols including graft polyols, polyisocyanate polyaddition polyols, polymer polyols, PHD polyols and mixtures thereof.

Lower molecular weight compounds include lower molecular weight polyether polyols, polyester polyols and other dials and trials, which may also be referred to as chain extenders and/or crosslinkers.

Preferred polyols for inclusion in the isocyanate-reactive component(s) used in the practice of the present invention include polyol blends or mixtures of polyether polyols and/or polyester polyols.

In accordance with the present invention, polyethers containing at least one, generally from 2 to 8, preferably 3 to 6, hydroxyl groups and having a number average molecular weight of from 100 to 10,000 of known type may be used in the polyol blend. These are prepared, for example, by the polymerization of epoxides, such as ethylene oxide, propylene oxide, butylene oxide, tetrahydrofuran, styrene oxide, or epichlorohydrin, either alone in the presence of for example BF₃, or by chemical addition of these epoxides, optionally as mixtures or successively, to starting components having reactive hydrogen atoms, such as alcohols or amines, water, ethylene glycol, propylene glycol-(1,3) or -(1,2), trimethylol propane, 4,4-dihydroxy diphenyipropane aniline, ammonia ethanolamine or ethylene diamine. Sucrose polyethers which have been described, for example in German Auslgeschrift Nos. 1,176,358 and 1,064,938 may also be used and are preferred. It is particularly preferred to use polyethers with OH numbers above 200.

Typically, these polyether polyols have an OH functionality of at least 2, preferably at least 3, and most preferably at least 4. These polyether polyols also typically have an OH functionality of less than or equal to 8.0, and preferably less than or equal to 6.0. The polyether polyols of the invention may have an OH functionality ranging between any combination of these upper and lower values, inclusive, e.g. from 2.0 to 8.0, and preferably from 3.0 to 6.0.

The polyether polyols useful in the practice of the present invention typically have an OH number of at least 250, preferably at least 300 and most preferably at least 350. These polyether polyols also typically have an OH number of less than or equal to 1050 mg KOH/g, preferably less than or equal to 800 and more preferably less than or equal to 700. The polyether polyols may have an OH number ranging between any combination of these upper and lower values, inclusive, e.g., from 250 to 1050 mg KOH/g, preferably from 300 to 700, and more preferably from 350 to 650.

It is also preferred to include polyethers with OH numbers between 14 and 56 mg KOHIg to increase flexibility and impact resistance of the resulting foams. The amount of high molecular weight polyether(s) added should be less than 30%, preferably less than 20%, and most preferably less than 15%, by weight of the polyol portion of the polyurethane foams.

Polyester polyols may also be included in the isocyanate-reactive component of the present invention. Suitable polyester polyols generally contain at least two hydroxyl groups, and have a molecular weight of from 400 to 4000, in particular polyesters containing from 2 to 8 hydroxyl groups, preferably those having a molecular weight of from 350 to 3000, more preferably from 350 to 2000. These polyesters are generally used in amounts no greater than 60% of the polyol portion of the polyurethane foams.

Examples of suitable polyesters containing hydroxyl groups include reaction products of polyhydric, preferably dihydric and optionally trihydric, alcohols with phthalic acids and other polybasic, preferably dibasic, carboxylic acids. Instead of using the free phthalic acids or polycarboxylic acids, the corresponding acid anhydrides or corresponding acid esters of lower alcohols or mixtures thereof may be used for preparing the polyesters. Ortho-phthalic acids, isophthalic acids and/or terephthalic acids may be used as the phthalic acid. Other suitable polybasic-carboxylic acids include aliphatic, cycloaliphatic, aromatic and/or heterocyclic and may be substituted, for example, with halogen atoms and/or may be unsaturated. Examples of suitable acids include: succinic acid, adipic acid, suberic acid, azelaic acid, sebacic acid, trimellitic acid, tetrahydrophthalic acid anhydride, hexahydrophthalic acid anhydride, endomethylene tetrahydro phthalic acid anhydride, glutaric acid anhydride, maleic acid, maleic acid anhydride, fumaric acid, dimeric and trimeric fatty acids, such as oleic acid, optionally mixed with monomeric fatty acids. Suitable polyhydric alcohols include: ethylene glycol, propylene glycol-(1,2) and -(1,3), diol-(1,8), neopentyl glycol, cyclohexane dimethanol (1,4-bis-hydroxymethylcyclohexane), 2-methyl-1,3-propane diol, glycerol, trimethylolpropane, hexanetriol-(1,2,6) butane trial-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, and polybutylene glycols.

The polyesters may also contain carboxyl end groups. Polyesters of lactones, such as ε-caprolactone, or hydroxycarboxylic acids, such as δ-hydroxycaproic acid, may also be used.

Preferred polyester polyols for the use in the practice of the present invention are the polyesters of lactones or the reaction products of i) adipic acid and ii) low molecular weight aliphatic diol compounds. Molecular weights of these preferred polyesters are from 500 to 3000, preferably from 1000 to 2000. Particularly preferred polyester polyols for use in the practice of the present invention include the reaction products of (i) phthalic acid compounds and (ii) low molecular weight aliphatic diol compounds. Number average molecular weights of these particularly preferred polyesters are from 350 to 700, preferably 350 to 600. Such polyester polyols are described in U.S. Pat. Nos. 4,644,047 and 4,644,048, the disclosures of which are hereby incorporated by reference.

Polythioethers which may also be included in the polyol component used in the practice of the present invention are the condensation products obtained from thiodiglycol alone and/or with other glycols, dicarboxylic acids, formaldehyde, aminocarboxylic acids or aminoalcohols. The products obtained are polythio mixed ethers, polythio ether esters or polythio ether ester amides, depending on the co-components.

Polyhydroxyl compounds already containing urethane or urea groups and modified or unmodified natural polyols, such as castor oil, carbohydrates or starch may also be used in the practice of the present invention. Addition products of alkylene oxides and phenyl/formaldehyde resins or of alkylene oxides and urea/formaldehyde resins are also suitable according to the present invention.

Representatives of these compounds which may be used in the practice of the present invention have been described, for example, in High Polymers, Volume XVI, “Polyurethanes, Chemistry and Technology”, by Saunders and Frisch, Interscience Publishers, New York; London, Volume I, 1962, pages 32-42 and pages 44 to 54 and Volume 11, 1964, pages 5 and 6 and 198-199, and in Kunststoff-Handbuch, Volume VII, Vieweg-Hochtlen, Carl-Hanser-Verlag, Munich, 1966, for example, on pages 45 to 71.

Suitable for use as the lower molecular weight component of the isocyanate-reactive component in addition to the above-described polyols having a number average molecular weight no greater than 450 are chain extenders and crosslinkers. These low molecular weight components typically have hydroxyl functionalities ranging from 1.5 to 4.0, molecular weights ranging from 62 to 450 and OH numbers ranging from 250 to 1900.

Such low molecular weight components typically have hydroxyl functionalities of at least 1.5 and preferably at least 2.0. These low molecular weight components also typically have a hydroxyl functionality of less than or equal to 4.0, and preferably less than or equal to 3.0. The polyether polyols of the invention may have an OH functionality ranging between any combination of these upper and lower values, inclusive, e.g. from 1.5 to 4.0, and preferably from 2.0 to 3.0.

The low molecular weight components typically have molecular weights of at least 62 and preferably at least 100. These components also typically have number average molecular weights of less than or equal to 450, and preferably less than or equal to 300. The chain extenders and/or crosslinkers which may be used in the practice of the present invention may have a molecular weight ranging between any combination of these upper and lower values, inclusive, e.g. from 62 to 450, and preferably from 100 to 300.

These low molecular weight components typically have hydroxyl numbers of at least 250 mg KOH/g and preferably at least 350. These components also typically have hydroxyl numbers of less than or equal to 1900 mg KOH/g, and preferably less than or equal to 1100. The chain extenders and/or crosslinkers useful in the practice of the present invention may have hydroxyl numbers ranging between any combination of these upper and lower values, inclusive, e.g. from 250 to 1900, and preferably from 350 to 1100.

Some examples of suitable chain extenders include: ethylene glycol; 1,2- and 1,3-propanediol; 1,3-, 1,4- and 2,3-butanediol; 1,6-hexanediol; 1,8-octanediol; 1,10-decanediol; neopentyl glycol; 1,3- and 1,4-bis(hydroxymethyl) cyclohexane; 2-methyl-1,3-propanediol; diethylene glycol; triethylene glycol; tetraethylene glycol; polyethylene glycols; dipropylene glycol; tripropylene glycol; polypropylene glycols; dibutylene glycol; tributylene glycol; polybutylene glycols; N-methyl-diethanolamine; cyclohexane-dimethanol; 2-methyl-1,3-propanediol; and 2,2,4-trimethyl-pentane-1,3-diol. Other suitable chain extenders are amine-started polyethers such as the alkoxylation products of ethylenediamine, toluenediamine, monoethanolamine, diethanolamine, and triethanolamine, etc.

Also suitable are mixtures of the above chain extenders with higher functional compounds such as glycerol and/or trimethylolpropane, provided that the overall functionality of the mixture falls with the required range for chain extenders described herein. Any of the previously mentioned dials that are disclosed herein as being suitable for preparing polyesters are also suitable as chain extenders. Preferred chain extenders are diethylene glycol and mixtures of dipropylene with tripropylene glycol.

Suitable crosslinking agents useful in the practice of the present invention include compounds such as trimethylolpropane, pentaerythritol, glycerine and the lower molecular weight polyethers formed from glycerine and propylene oxide, which are preferred.

One isocyanate-reactive component suitable for use in a polyurethane foam-forming reactive mixture in the practice of the present invention includes:
(a) 30 to 70 parts by weight of at least one polyester polyol having a functionality of from 1.5 to 3.0 and an OH number of from 25 to 250 mg KOH/g, and which comprises the reaction product of

(i) one or more aliphatic dicarboxylic acids, with

(ii) one or more dials or trials;
(b) 20 to 40 parts by weight of at least one highly branched polyether polyol having a functionality of 3.0 to 8.0 and an OH number of 250 to 750 mg KOH/g (preferably prepared by alkoxylating sucrose or a mixture of sucrose and one or more other suitable starter compounds);
   and
(c) 10 to 30 parts by weight of at least one chain extender having a hydroxyl functionality of from 2.0 to 2.9 and an OH number of from 400 to 1900 mg KOH/g,
   with the sum of the parts by weight of (a), (b), (c) and any water present totaling 100 parts by weight of the isocyanate-reactive component.

When using this particular isocyanate-reactive component to form a water blown polyurethane composition in the practice of the present invention, it is preferably reacted with (a) 80 to 160 parts by weight of polymethylene poly(phenyl isocyanate), an isocyanate group containing prepolymer based on a polymethylene poly(phenyl isocyanate), or mixtures thereof having an NCO group content of from 25 to 33% by weight; (b) water in a sufficient amount to result in a medium density (i.e. 10 to 30 pcf) polyurethane foam; and (c) a solid flame retardant composition in the presence of the glass fibers having a length of from 12.5 to 50 mm and the filler(s) which is/are not glass fibers having a length of from 12.5 to 50 mm but which do have an average particle size of from 0.3 to 40 microns, preferably, from 5 to 15 microns.

A preferred isocyanate-reactive component to be used in accordance with the present invention comprises
(a) from 30 to 70 (preferably 45 to 65) parts by weight of at least one polyester polyol having a functionality of 2.0 to 3.0 and an OH number of 160 to 320 mg KOH/g that is the reaction product of one or more polyhydric alcohols with one or more phthalic acids or other polybasic (preferably dibasic) carboxylic acids, corresponding acid anhydrides or corresponding acid esters;
(b) 0 to 35 (preferably 0 to 25) parts by weight of a polyether polyol having a functionality of from about 1.5 to about 3 and an OH number of from about 14 to about 56 mg KOH/g;
(c) 0 to 30 parts by weight of at least one highly branched polyether polyol having a functionality of 3.0 to 8.0 and an OH number of 250 to 750 mg KOH1g (preferably prepared by alkoxylating sucrose or a mixture of sucrose and one or more other suitable starter compounds);
   and
(d) from 0 to 30 (preferably 10 to 25) parts by weight of one or more chain extenders and/or one or more crosslinking agents,
   with the sum of the parts by weight of (a), (b), (c), (d) and any water present totaling 100 parts by weight of the isocyanate-reactive component.

In this preferred isocyanate-reactive component, the polyester polyol, component (a), preferably has a functionality of 2.0 to 3.0 and preferably has an OH number of 160 to 320 mg KOH/g. This polyester polyol component is preferably the reaction product of phthalic acid anhydride and diethylene glycol.

The preferred polyether polyols to be used as component (b) in this preferred isocyanate-reactive component, have a functionality of 1.8 to 3.5 and have an OH number of 14 to 56 mg KOH/g. These polyether polyols are preferably the reaction product of glycerine and a mixture of ethylene and propylene oxide.

The preferred polyether polyols to be used as component (c) in this preferred isocyanate-reactive component, have a functionality of 4 to 6 and have an OH number of 250 to 400 mg KOH/g. These polyether polyols are preferably the reaction product of a mixture of sucrose and water and/or propylene glycol and propylene oxide.

Preferred chain extenders and/or crosslinkers for component (d) of the above isocyanate-reactive component include diethylene glycol, tripropylene glycol, and gylcerine adducts with propylene oxide. These chain extenders and/or crosslinkers preferably have functionalities of 2.0 to 3.0 and OH numbers of 550 to 1100 mg KOH/g.

The glass fibers having a length of from 12.5 to 50 mm included in the foam-forming reaction mixture are generally included in an amount of from 5 to 40% by weight, preferably, from 10 to 35% by weight, most preferably, from 20 to 35% by weight, based on total weight of the foam. Suitable glass fibers are characterized by lengths of from 12.5 to 50mm, preferably, from 20 to 40 mm, most preferably, about 25mm. Examples of commercially available glass fibers that are suitable for use in the practice of the present invention include: PPG 5509, Ashland ER58C, and DCV ME1020.

The filler included in the foam-forming mixture of the present invention is generally included in an amount of from 25 to 60% by weight, preferably, from 30 to 55% by weight, most preferably, from 35 to 50% by weight, based on total weight of the foam. Suitable filler materials include any of the known fillers with the exception of the glass fibers having lengths of from 12.5 to 50 mm already required and solid flame retardants. Suitable fillers are characterized by particle sizes of from 0.3 to 40 microns, preferably, from 5 to 15 microns. Examples of suitable filler materials include: iron oxide, mica, wollastonite, and barium sulfate.

Solid flame retardants which may optionally be included in the foam-forming mixture are: (i) a melamine coated ammonium polyphosphate, (ii) zinc borate, and optionally, (iii) one or more metal oxides or hydrates. The metal oxides or hydrates include, but are not limited to, alumina trihydrate, magnesium compounds such as, magnesium hydroxide, calcium hydroxide, and the various antimony oxides. Suitable antimony oxides are antimony pentaoxide and antimony trioxide.

Other potential additives and auxiliary agents to be included in the polyurethane foam compositions used in the practice of the present invention include: catalysts, surface-active additives such as emulsifiers and foam stabilizers, as well as, known internal mold release agents, pigments, cell regulators, plasticizers, and dyes.

Some examples of suitable catalysts, include tertiary amine catalysts and organometallic catalysts. Some examples of suitable organometallic catalysts include, for example organometallic compounds of tin, lead, iron, bismuth, mercury, etc. Also suitable are heat-activated amine salts as catalysts. These include both aliphatic and aromatic tertiary amines. It is preferred to use heat activated amine salts as catalysts. The amount of catalyst used in the practice of the present invention is that which is conventionally used in such systems, i.e., from about 0.05 to about 5% by weight. That reaction time is significantly reduced in the process of the present invention while the amount of catalyst included in the polyurethane foam-forming mixture is not increased is considered surprising and was unexpected.

Examples of emulsifiers and foam stabilizers include: N-stearyl-N′,N′-bis-hydroxyethyl urea, oleyl polyoxyethylene amide, stearyl diethanol amide, isostearyl diethanol-amide, polyoxyethylene glycol monoleate, a pentaerythritol/adipic acid/-oleic acid ester, a hydroxy ethyl imidazole derivative of oleic acid, N-stearyl propylene diamine and the sodium salts of castor oil sulfonates or of fatty acids. Alkali metal or ammonium salts of sulfonic acid such as dodecyl benzene sulfonic acid or dinaphthyl methane sulfonic acid and also fatty acids may be used as surface-active additives.

Suitable foam stabilizers also include polyether siloxanes. The structure of these compounds is generally such that a copolymer of ethylene oxide and propylene oxide is attached to a polydimethyl siloxane radical. Such foam stabilizers are described in U.S. Pat. No. 2,764,565.

In accordance with the present invention, the various additives and auxiliary agents, as well as liquid flame retardants and/or polyvinyl chloride can be added to either the isocyanate-reactive component of the polyurethane foam forming reactive mixture, and/or, if these do not contain isocyanate-reactive groups, they can be added to the isocyanate-component of the polyurethane foam forming reactive mixture. Obviously, these additives, auxiliary agents, liquid flame retardants and/or polyvinyl chloride may also be added as separate components to the polyurethane foam forming reactive mixture.

The polyurethane foam compositions produced in accordance with the present invention may be molded using conventional processing techniques at isocyanate indexes ranging from about 90 to 150 (preferably from 100 to 130). The term “Isocyanate Index” (also commonly referred to as “NCO index”), is defined herein as the equivalents of isocyanate, divided by the total equivalents of isocyanate-reactive hydrogen containing materials, multiplied by 100.

In an open mold process, the reacting materials are poured into a mold (not injected into the mold). The materials suitable for processing in open molds are normally characterized by having a slightly longer gel time and curing time than those used in the closed mold (typical RIM) processes.

In the process of preparing molded polyurethane foams from these foam forming compositions, one typically introduces a polyurethane foam forming composition into an open mold, closes the mold, allows the composition to react, and removes the molded polyurethane foam from the mold. Suitable information in terms of relevant conditions, suitable molds, demold times, end uses, etc. are known by those skilled in the art. It is preferred that the free rise density of foam is between 8 and 20 pcf (pounds per cubic foot) (i.e., between 0.13 gm/cm³ and 0.32 gm/cm³) and that the molded density of the foams is between about 12 and 24 pcf (i.e., between 0.17 and 0.38 gm/cm³).

It is also possible, but less preferred, to use a traditional RIM process or other closed mold process to prepare molded parts from the polyurethane foam forming compositions described herein.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Fahrenheit and all parts and percentages are parts by weight and percentages by weight, respectively.

### EXAMPLES

The present invention is further illustrated, but is not to be limited, by the following examples. All quantities given in “parts” and “percents” are understood to be by weight, unless otherwise indicated.

The following components were used in the working examples:
POLYOL A: an aromatic polyester polyol (i.e. a polydiethylene glycol phthalate having a functionality of two and a hydroxyl number of about 192 mg KOH/g (commercially available from Stepan Company of Northfield, Ill. as Stepanpol PS-1922).
POLYOL B: a glycerine-initiated polyether polyol having an OH number of about 36 mg KOH/g and a nominal functionality of about 3 (commercially available from Bayer MaterialScience as Hyperlite E-824).
POLYOL C: diethylene glycol.
POLYOL D: polypropylene glycol with a functionality of two and OH number of about 425 (commercially available from Bayer MaterialScience as Arcol Polyol PPG-425).
SURFACTANT: a polyalkylene oxide methyl siloxane copolymer commercially available from Air Products and Chemicals of Allentown, Pa. as Dabco® DC-198.
CATALYST A: an acid blocked amine blowing catalyst, commercially available from Momentive Performance Materials of Albany, N.Y. as Niax® A-107.
CATALYST B: an acid blocked amine catalyst commercially available from Momentive Performance Materials of Albany, N.Y. as Niax® C-177.
AAA: Alkylamino acid amide.
ER 1268: Flame retardant blend available from US Borax Inc.
DPU-B2371-2B: Pigment powder available from Clariant Corp.
HUBERCARB W4: Calcium carbonate available from Huber Corp.
ISOCYANATE A: Modified polymeric methylene (diphenyl diisocyanate) having an NCO group content of about 30.4% by weight (commercially available from Bayer MaterialScience as Mondur 1515).
ISOCYANATE B: Polymeric methylene (diphenyl diisocyanate) having an NCO group content of about 31.4% by weight (commercially available from Bayer MaterialScience as Mondur MR.
GLASS FIBERS: E Glass Roving with 4800 Tex available from PPG.
FILLER: melamine coated ammonium polyphosphate plus ER 1268 plus DPU-B2371-2B).

Glass fiber reinforced polyurethane foams were prepared from the materials listed in Table 1 in the amounts (in parts by weight) listed in Table 1 by the following procedure:

The Isocyanate and the polyol blend which included all the additives and fillers were mixed using Krauss Maffei LFI machine. The glass fiber was chopped and added through the LFI head. The material was poured into a heated (130-170° F.), open mold. The mold was then closed and the material allowed to cure for a period between 3 to 8 minutes prior to demolding.

The properties of these foams are also reported in Table 1.

TABLE 1

| Example | 1 | 2 | 3 | 4 |
|---|---|---|---|---|
| POLYOL A | 52.76 | 52.76 | 52.76 | 51.12 |
| POLYOL B | 20.87 | 20.87 | 20.87 | 20.22 |
| POLYOL C | 22.36 | 22.36 | 22.36 | 21.67 |
| POLYOL D | 2.7 | 2.7 | 2.7 | 2.61 |
| SURFACTANT | 1.5 | 1.5 | 1.5 | 1.45 |
| CATALYST A | 0.1 | 0.1 | 0.1 | 0.1 |
| CATALYST B | 0.5 | 1.3 | 1.3 | 1.26 |
| WATER | 0.5 | 0.5 | 0.3 | 0.3 |
| AAA | 1.0 | 1.0 | 1.0 | 0.97 |
| HUBERCARB W4 | — | — | 34.17 | 46.49 |
| ISOCYANATE A | | | 109 | 109 |
| ISOCYANATE B | 102 | 102 | | |
| GLASS FIBER | 10 | 5 | 10 | 5 |
| FILLER | 57.8 | 57.8 | 57.8 | 57.8 |
| Density (gm/cm³) | 0.172 | 0.172 | 0.39 | 0.34 |
| Notched Izod | 12 | 8 | 12 | 8 |
| impact resistance | | | | |
| (ft-lb/in.) | | | | |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A molded glass-reinforced, filled polyurethane foam having a density of from 10 to 50 pounds per cubic foot and having a notched Izod impact resistance between about 5 and about 14 foot-pounds/inch comprising a reaction product of:
a) a polyurethane-forming reaction mixture,
b) from 5 to 35% by weight, based on total weight of the foam, of glass fibers having a length of from 12.5 to 50 mm,
c) from 25 to 60% by weight, based on total weight of the foam, of at least one filler which is different from b), and
d) a blowing agent comprising water
formed in a mold.

2. The foam of claim 1 in which the polyurethane-forming reaction mixture comprises:
(1) from 10 to 35% by weight, based on total weight of the foam, of a polyol component
and
(2) from 10 to 35% by weight, based on total weight of the foam, of a polyisocyanate component.

3. The foam of claim 2 in which the polyol component comprises:
at least one polyether polyol having a functionality of from about 1.8 to about 3.5 and an OH number of from about 14 to about 56,
(ii) at least one polyether polyol having a functionality of from about 4 to about 6 and an OH number of from about 250 to about 1050,
(iii) optionally, a polyester polyol,
and
(iv) optionally, a chain extender.

4. The foam of claim 3 in which the polyisocyanate component comprises at least one polyisocyanate selected from polymeric MDI (“PMDI”), urethane-modified PMDI, urethane prepolymers of diphenylmethane diisocyanate, carbodiimides of diphenylmethane diisocyanate, allophanates of diphenylmethane diisocyanate and mixtures thereof.

5. The foam of claim 2 in which the polyisocyanate component comprises at least one polyisocyanate selected from polymeric MDI (“PMDI”), urethane-modified PMDI, urethane prepolymers of diphenylmethane diisocyanate, carbodiimides of diphenylmethane diisocyanate, allophanates of diphenylmethane diisocyanate and mixtures thereof.

6. The foam of claim 1 in which the glass fibers are in the form of a mat.

7. The foam of claim 1 in which the glass fibers are chopped fibers having an average length of about 25 mm.

8. The foam of claim 1 in which the filler is selected from calcium carbonate, solid flame retardants, barium sulfate, milled glass, wollastonite, mica and talc.

9. The foam of claim 1 in which the total of % by weight of glass fibers plus % by weight of filler is equal to from 30 to 80% by weight.

10. The foam of claim 1 in which from 15 to 30% by weight of glass fibers are included.

11. The foam of claim 1 in which from 15 to 55% by weight of filler are included.

12. The foam of claim 1 having a molded density of from 0.17 to 0.38 gm/cm³.

13. The foam of claim 1 having a notched Izod impact resistance as measured by ASTM D 256 of from 5 to 10 foot-pounds per inch.

14. A molded glass-reinforced, filled polyurethane foam haying a density of from 10 to 50 pounds per cubic foot and having a notched Izod impact resistance between about 5 and about 14 foot-pounds/inch comprising a reaction product of:
a) a polyurethane-forming reaction mixture,
b) from 5 to 35% by weight, based on total weight of the foam, of glass fibers having a length of from 12.5 to 50 mm,
c) from 25 to 60% by weight, based on total weight of the foam, of at least one filler which is different from b), and
d) a blowing agent consisting of water.

15. A process for the production of a molded glass-reinforced, filled polyurethane foam having a density of from 10 to 50 pounds per cubic foot having a notched Izod impact resistance of from 5 to 14 foot-pounds per inch comprising reacting:
a) a polyurethane-forming reaction mixture, in the presence of
b) from 5 to 35% by weight, based on total weight of the foam, of glass fibers having a fiber length of from 12.5 to 50 mm,
c) from 25 to 60% by weight, based on total weight of the foam, of at least one filler in particulate form having an average particle size of from 0.3 to 40 microns, and
d) a blowing agent comprising water
in a mold.

16. The process of claim 15 comprising an injection molding process.

17. A roofing tile produced by the process of claim 15.

18. A pallet produced by the process of claim 15.
